(19) United States
(12) Patent Application Publication
(10) Pub. No.: US 2013/0206269 A1
(43) Pub. Date: Aug. 15, 2013

(54) Honeycomb-Body-Based Fluidic Interconnectors and Methods

(71) Applicant: James Scott Sutherland, Corning, NY (US)

(72) Inventor: James Scott Sutherland, Corning, NY (US)

(21) Appl. No.: 13/696,381

(22) PCT Filed: May 26, 2011
(86) PCT No.: PCT/US11/38023

§ 371 Date: Nov. 6, 2012

Related U.S. Application Data
(60) Provisional application No. 61/349,983, filed on May 31, 2010.

(51) Int. Cl. F16L 9/19

(52) U.S. Cl. CPC F16L 9/19
USPC 138/111; 29/428

(57) ABSTRACT

Inter connectors for fluidically connecting reactor modules in a millimeter scale continuous flow reactor or the like is disclosed, the interconnectors including a honey-comb-body substrate having first and second ends and a plurality of channels extending along a common direction as well as a structure formed on or in the substrate for attaching an interface clamp to the substrate. The interconnectors further have one or more open channnels extending through the substrate and a plurality of closed channels closed off by a plugging material at the ends of the substrate and surrounding the one or more open channels. Methods of making the interconnectors are also disclosed.

This application claims the benefit of priority of U.S. application Ser. No. 61/349,983 filed on May 31, 2010.

### BACKGROUND

This disclosure relates in general fluid to interconnectors for continuous flow chemical reactors general having continuous flow passages of millimeter scale hydraulic diameter, and in particular to fluidic interconnectors fabricated from honeycomb extrusion substrates and to methods for providing such interconnectors.

### SUMMARY

According to one embodiment of the present disclosure, an interconnector for fluidically connecting reactor modules in a millimeter-scale continuous flow reactor or the like is provided, the interconnectors including a honeycomb-body substrate having a plurality of channels extending along a common direction and a structure formed on or in the substrate for attaching an interface clamp to the substrate. The interconnectors have one or more open channels extending through the substrate and a plurality of closed channels closed off by a plugging material at the ends of the substrate and surrounding the one or more open channels.

According to another embodiment of the present disclosure a method of making a fluidic connector for fluidically connecting reactor modules in a millimeter scale continuous flow reactor is provided, the method comprising: (1) machining or cutting out a smaller extruded body substrate from a larger green extruded body, the substrate having channels extending along a common direction, the substrate having first and second ends from which and to which the channels extend; (2) machining or otherwise forming one or more structures in or on the substrate for attaching an interface clamp to the substrate; and (3) plugging a plurality of the channels with a plugging material at both ends of the substrate, the plurality of channels being plugged positioned around and surrounding one or more contiguous open channels.

Other features and advantages of the present invention will be apparent from the figures and following description and claims.

### BRIEF DESCRIPTION OF THE FIGURES

FIG. 1 is a perspective views of one embodiment a component of honeycomb-body based fluidic interconnector;

FIG. 2 is a perspective views of another embodiment of a component of honeycomb-body based fluidic interconnector;

FIG. 3 is a perspective views of one embodiment of component of a honeycomb-body based fluidic interconnector;

FIG. 4 is a perspective view of the embodiment of the honeycomb-body based fluidic interconnector of FIG. 3 with additional components;

FIG. 5 is a cross-sectional view of the embodiment of a honeycomb-body based fluidic interconnector of FIG. 4;

FIG. 6 is a cross-sectional view of an alternative embodiment of a honeycomb-body based fluidic interconnector, alternative to FIG. 5.

FIG. 7 is a cross-section view of an embodiment of a monolithic interconnector connected between two fluidic modules according to one aspect of the present disclosure;

FIG. 8 is a cross section of an embodiment of a honey-comb-body-based interconnector with integrated heat exchange;

FIG. 9 is a plan view cross-section of the interconnector of FIG. 8;

FIG. 10 is a cross section of a honey-comb-body-based interconnector (monolithic interconnector) with an integrated clamping structure;

FIGS. 11 and 12 are plan views of an end face of two different embodiments of honey-comb-body-based interconnectors; and

FIG. 13 is a cross section of a multiple-path honeycomb-based interconnector according to yet another embodiment of the present disclosure.

### DETAILED DESCRIPTION

The present inventor and various colleagues have previously developed the capability to provide complex continuous flow chemical reactors built up from glass or other-material fluidic modules generally having flow passages with hydraulic diameters in the millimeter range. See, for example, patents and/or patent publication Nos. U.S. Pat. No. 7,007,709 and EP1854543, issued to the present assignee. Fluidic interconnectors are required between glass fluidic modules to convey reactants from one module to another. The fluidic interconnectors must meet all or most of the requirements currently addressed by the glass fluidic modules, such as high pressure resistance, operation over a wide temperature range, and resistance to chemical erosion from a broad range of reactants. Providing fluidic interconnectors capable of both high pressure and high temperature operation can be difficult. Additionally, fluidic interconnectors desirably have a relatively small internal volume and corresponding low resulting residence time, particularly because fluidic interconnectors are generally not capable of maintaining the temperatures of reactants within the interconnector at a fixed value, so that residence time in the interconnector is desirably minimized.

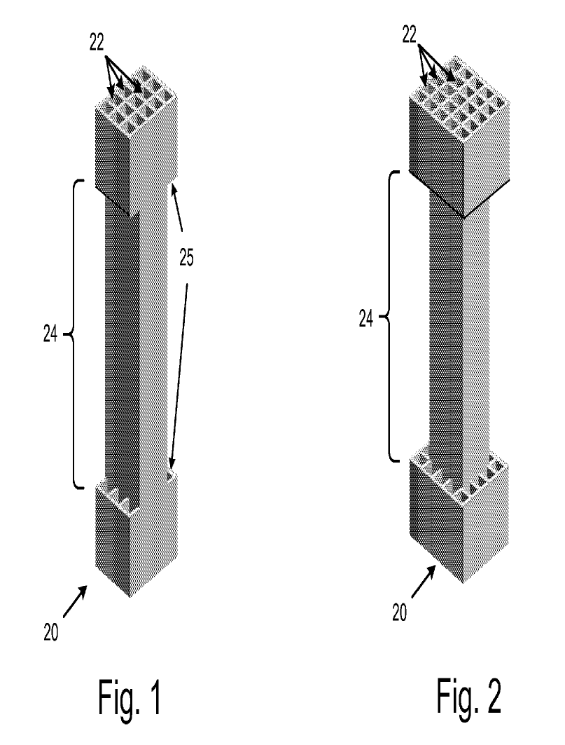

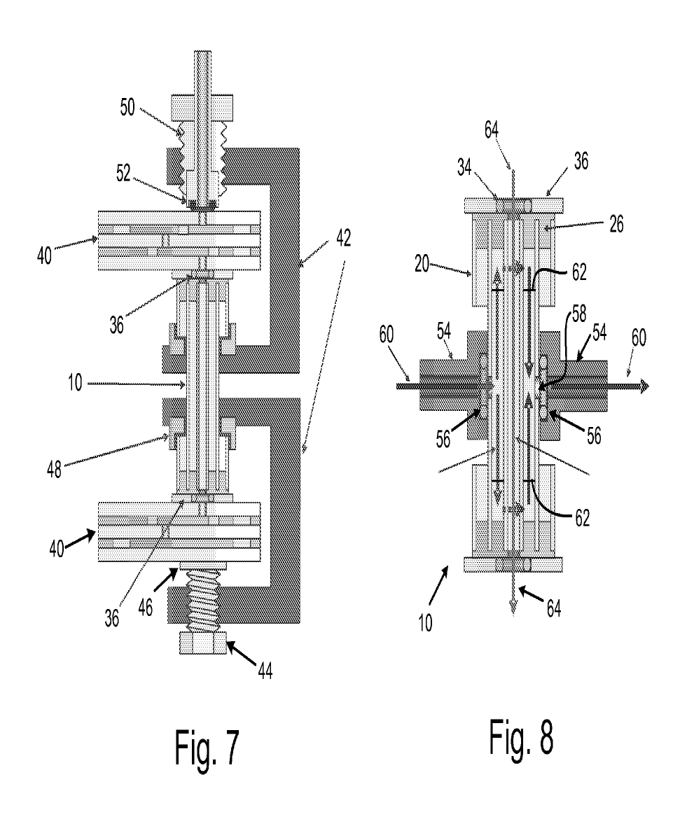

This disclosure describes a technique for providing interconnectors for micro-reactor fluidic modules using a monolithic interconnector device, of which the basic features and desirable fabrication method for a few embodiments will be described with reference to FIGS. 1-4. Monolithic interconnector devices are desirably fabricated by first machining green honeycomb extrusion substrates 20. FIG. 1 shows an example where a rectangular substrate 20 having multiple parallel channels 22 has been sawed out of a larger extrusion, and then one or more machined regions 24 have been formed, in this case on two on opposing sidewalls of the four sidewalls of the substrate 20. This machining may be carried out rapidly using a sanding belt and a fixturing jig, for example. Other cutting or grinding tools may also be used, including laser cutters, water jets, or other suitable technologies. In the embodiment shown, formation of the machined region produces two ledges 25 near each end face that may be engaged by an external clamp or clamping fixture 40 such as that shown in FIG. 7 to hold the resulting monolithic interconnector 10 in contact with a reactor fluid module 40 and an interface O-ring 36. The machined region 24 may also be formed on three or four substrate sidewalls, as shown in the embodiment of FIG. 2. If desired, machined features other than or in addition to ledges may be formed and used to hold the part in contact with an adjacent reactor fluidic module, such as notches, slots and holes (not shown) that engage the clamp 42.

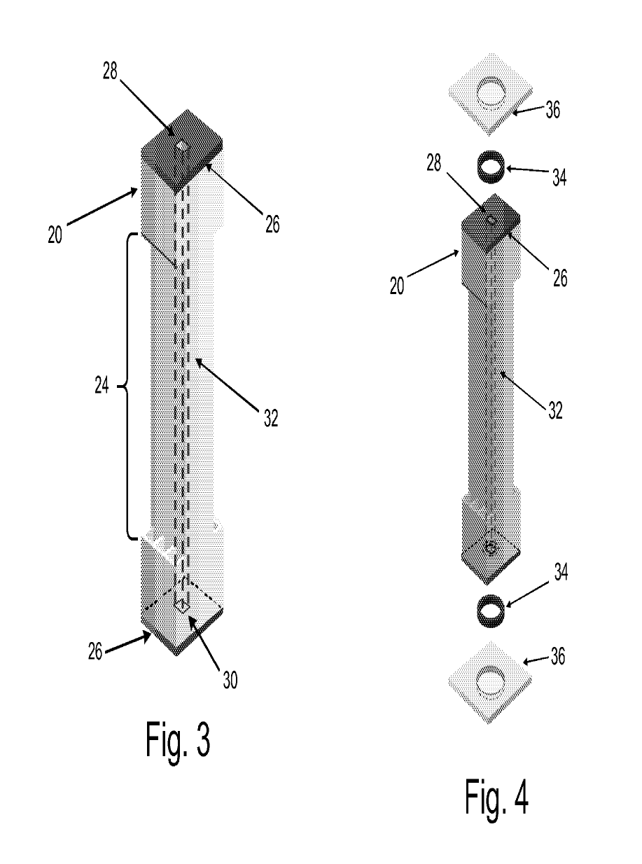

As seen in FIG. 3, after machining is complete the part is sintered and plug material 26 is applied to selected ones of the channels 22 at the end faces of the substrate 20 such that one or more end face channels 32 remain unplugged. These unplugged channel(s) 32 will serve to guide reactant fluid or other process fluid thorough the monolithic interconnector 10 from a first process fluid port 28 to a second one 30.

After substrate end face plugging the end face plug material 26 may be polished to serve as an O-ring bearing surface. Alternatively a plug sintering process may leave the end face plug material 26 in a naturally smooth state due to plug softening and flow so that polishing is not required.

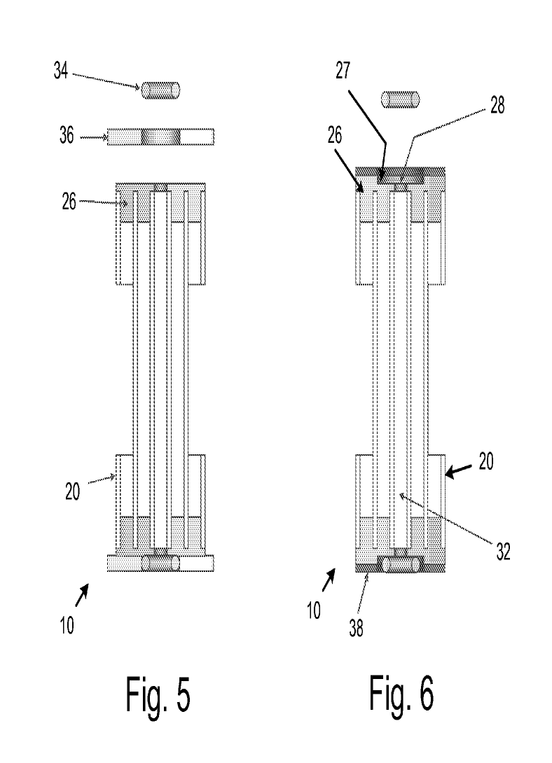

Prior to assembly in a reactor system O-rings 34 may be applied on each end face of the monolithic interconnector 10 as shown in FIG. 5. O-ring plates 36 may also be positioned on the end faces to restrain the O-rings during assembly and in use.

As an alternative to O-ring plates 26, the O-ring(s) 34 may be restrained by molding O-ring groove features 27 into the substrate end face plug material 26 prior to sintering as shown in FIG. 6. The O-ring groove desirably be formed of glass frit in these embodiments. The O-ring support may be made more robust by having a broad area of the plugging material 26 raised as in FIG. 6, and not just a small circular region of material, so that the O-ring 34 is restrained during pressurization by a larger region or cross section of material.

A thin resilient layer 38 such as a polymer material with pressure sensitive adhesive backing may be applied to a portion of plugged end face to prevent glass-glass or glass-ceramic contact at the end face during assembly.

FIG. 7 provides a cross-section view of a monolithic interconnector positioned between two glass fluidic modules. Two interface clamps 42 hold the monolithic interconnector 10 in position against respective glass fluidic modules 40 by engaging the ledge features near each end face. A clamp screw integral 44 to the interface clamp 42 may be turned to force the monolithic interconnector 10 to compress the O-ring 36 at each end face.

Clamp pads 48 may be positioned between the interface clamp and the monolithic interconnector ledge features to serve as a force spreader. The monolithic interconnector ledges may also include a corner fillets to minimize stress concentrations associated with sharp corners under or near the loading point on the ledge.

An advantage of using a ceramic monolithic interconnector device is that device length changes due to excessively hot or cold reactant fluid flow will be minor Consider a configuration where glass fluidic modules are joined by more than one interconnector: One interconnector could convey reactant fluid while two others could deliver heat exchange fluid. The low CTE of the ceramic monolithic interconnector will ensure that the O-ring compression changes among the various interconnector O-rings will be minimal This performance is in contrast to PTFE/PFA interconnector materials, which are expected to change shape under thermal cycling.

The interface clamp can also be used to hold a non-honeycomb-body-based fluidic module O-ring interface component 50 in position. As shown at the top of FIG. 7, a non-honeycomb-body-base fluidic module O-ring interface component 50 may be mounted on one side of a glass fluidic module 40 (on the top side of the upper fluidic module 40 in this case), while the monolithic interconnector 10 nay be positioned over a fluidic port opposite the interface component 50 on the other side of the fluidic module 40. While FIG. 7 shows a monolithic interconnector 10 directly joining two glass fluidic modules 40, other configurations are possible, such as conditions where one monolithic interconnector is directly joined to another monolithic interconnector to extend the interconnector distance. In this case the interface clamp like the clamp 42 shown in FIG. 7 would be modified to grip the ledges on two mated monolithic interconnector devices.

Fluidic interconnectors between glass fluidic modules do not typically provide heat exchange fluid in close proximity to internal channels. Therefore special considerations must be made to minimize the internal volume of the fluid interconnector. If the internal volume of the fluid interconnector is too large, undesirable reaction side products may be generated as a consequence of the uncontrolled temperature within the interconnector device.

One potential advantage of using honeycomb extrusion substrates as monolithic interconnector devices is that channels adjacent to internal reactant channels can be used as heat exchange fluid channels. FIG. 8 provides a cross-section view of a monolithic interface where two side ports 58 have been added (with two shown but only one directly labeled in the figure). Heat exchange fluid O-rings 56 with corresponding interface fittings 54 are positioned over these side ports 58 so that heat exchange fluid may be injected into the monolithic interconnector on one side and removed on the other side, resulting in heat exchange fluid path 60 shown by the arrows in the figure. Inside the monolithic interconnector device 10 the heat exchange fluid may be routed along one or more serpentine up-and-down paths through the substrate 20. The serpentine path is defined via plunge machining operations or other suitable machining operations that form U-bends at various locations along the serpentine path. See, for example, the disclosure of US Patent Publication No. 20090169445, assigned to the present assignee. As shown in more detail in that publication, the U-bends result from the selective lowering of substrate walls, in combination with the plugs formed by plug material 26. The lowered walls 62 as indicated in FIG. 7 are lower or deeper into the substrate 20 than the plug material 26, thus allowing the heat exchange fluid to flow from channel to channel within the substrate 20 in a direction cross-wise to the common direction of the channels around a “U-bend.”

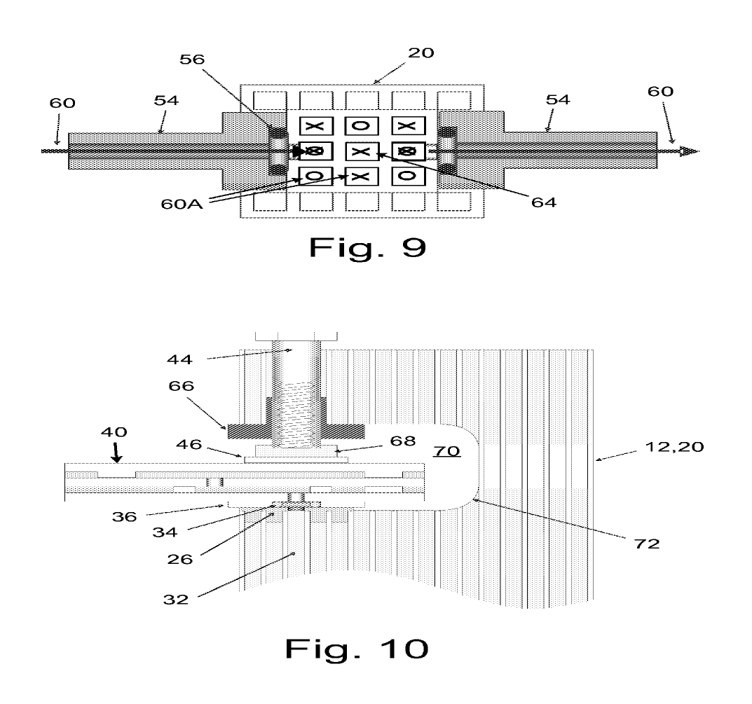

FIG. 9 shows a plan view cross-section of the monolithic interconnector internal channels of the monolithic interconnector of FIG. 8, illustrating how heat exchange fluid that enters the substrate 20 follows a path 60A within the substrate 20, being is directed upward and downward along two serpentine paths that pass on each side of the reactant channel 64 before joining at the fluid outlet. If desired, pressure drop along the heat exchange path may be further reduced using the side port designs such as those presented in FIGS. 12-14 of US Patent Publication No. 20090169445, mentioned above.

Part count and cost of a reactor system may potentially be reduced by integrating the interface clamp function with the monolithic interconnector as in the embodiment shown in FIG. 10, in which only the upper monolithic interconnector O-ring interface is shown for ease of illustration.

In the embodiment of FIG. 10, a honey-comb based interconnector (monolithic interconnector) with integrated clamp 12 is machined from a single piece of ceramic honeycomb extrusion substrate material while in the green state to produce a recess 70 for receiving a fluidic module 40. After sintering and plugging, a threaded bushing 66 is inserted into a hole drilled into the substrate parallel to the extrusion axis. The clamp screw 44 is threaded into this bushing 66 so that force is applied to the glass fluidic module 40 when the screw 44 is tightened. The clamping portion of the monolithic interconnector with integrated clamp 12 is made more robust and resistant to failure under mechanical stress by controlling the radius at the inside corners 72 of the device during manufacture to make sure it is sufficiently large.

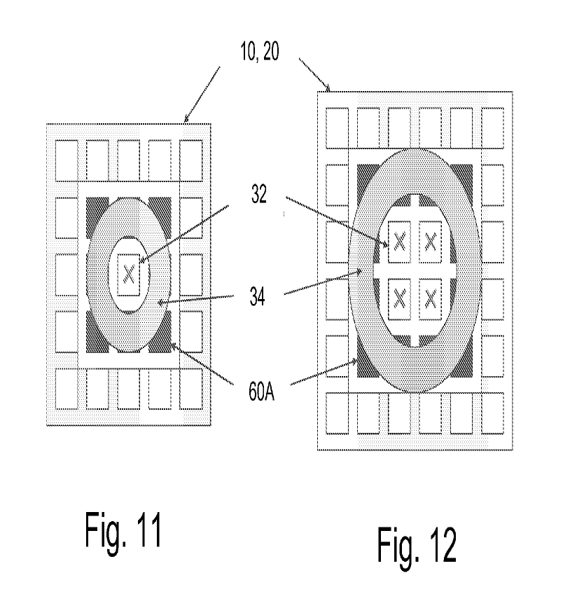

FIGS. 11 and 12 show plan views of monolithic interconnectors 10 with single (FIG. 11) and multiple (FIG. 12) parallel channels for a single interconnector. At high fluid flow rates the small cross-section associated with a single monolithic interconnector reactant channel 32 as in FIG. 11 may introduce undesirable high pressure drop across the device. This pressure drop may be reduced without compromising the mechanical integrity of the monolithic interconnector device 10 by employing multiple reactant channels 32 running adjacent to each other in parallel through the same substrate as in the embodiment of FIG. 12.

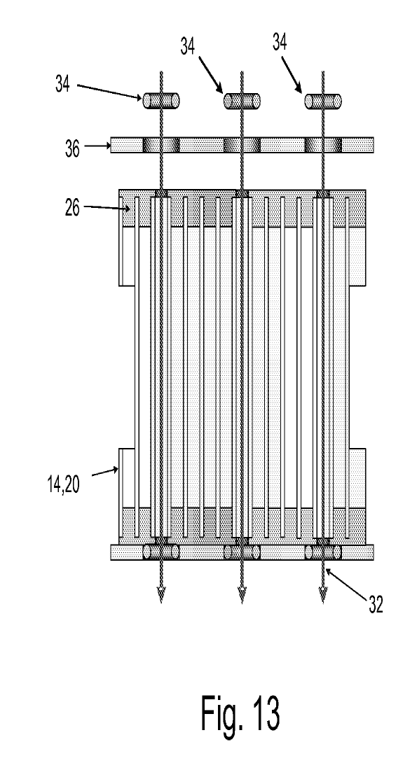

FIG. 13 shows multiple-path honeycomb-based interconnector (monolithic interconnector) 14 according to another alternative embodiment of the present invention. The monolithic interconnector 14 of FIG. 13 supports multiple fluidic interconnectors in parallel within a single substrate 20. This can further reduce the total piece count in a reactor system by providing in a single monolithic interconnector multiple fluidic channels for different fluids that extend into or through the same substrate. The cross-sectional view of FIG. 13 shows a monolithic interconnector device 14 with three separate internal channels in the plane of the cross section. This approach can simplify the assembly of chemical reactors, since fewer components must be joined to assemble a complete reactor, thus reducing costs.

The monolithic interconnectors 19, 12, 14 of the present disclosure may be fabricated in ceramic materials (e.g., alumina) to provide pressure resistance, resistance to chemical erosion and operation over a broad temperature range. While alumina is currently preferred, other ceramics, glass, and glass-ceramics could also be beneficially employed.

Although the modules 40 to be interconnected are depicted in the figures herein as flat layered fluidic modules, the same interconnector principles and interconnectors 10, 12, 14 herein disclosed may be beneficially used for other types of fluidic modules, including fluidic modules or fluid processing structures formed in honeycomb substrates.

The various embodiments of the methods and devices of the present disclosure provide one or more of the following significant advantages: The monolithic interconnectors may be easily fabricated in ceramic materials (e.g., alumina) to provide pressure resistance, resistance to chemical erosion and operation over a broad temperature range. Such substrates also remain rigid over a broad temperature range (unlike PTFE or other polymer interconnector materials). Low pressure drop fluidic interconnectors are possible, particularly by using multiple channels in parallel. The same substrate can be used to provide fluid interconnectors among multiple fluidic module input and output ports. The required monolith interconnector features are relatively easy to fabricate by machining in green honeycomb extrusion substrates. Packaging cost of the reactor can be reduced, and/or performance increased by integrating certain functions, such as clamping and/or heat exchange, into the body of the monolithic interconnector. When multiple fluidic interconnector paths are provided in a single substrate, overall part count and assembly complexity is reduced.

The methods and/or devices disclosed herein are generally useful in performing any process that involves mixing, separation, extraction, crystallization, precipitation, or otherwise processing fluids or mixtures of fluids, including multiphase mixtures of fluids—and including fluids or mixtures of fluids including multiphase mixtures of fluids that also contain solids—within a microstructure. The processing may include a physical process, a chemical reaction defined as a process that results in the interconversion of organic, inorganic, or both organic and inorganic species, a biochemical process, or any other form of processing. The following non-limiting list of reactions may be performed with the disclosed methods and/or devices: oxidation; reduction; substitution; elimination; addition; ligand exchange; metal exchange; and ion exchange. More specifically, reactions of any of the following non-limiting list may be performed with the disclosed methods and/or devices: polymerization; alkylation; dealkylation; nitration; peroxidation; sulfoxidation; epoxidation; ammoxidation; hydrogenation; dehydrogenation; organometallic reactions; precious metal chemistry/homogeneous catalyst reactions; carbonylation; thiocarbonylation; alkoxylation; halogenation; dehydrohalogenation; dehalogenation; hydroformylation; carboxylation; decarboxylation; amination; arylation; peptide coupling; aldol condensation; cyclocondensation; dehydrocyclization; esterification; amidation; heterocyclic synthesis; dehydration; alcoholysis; hydrolysis; ammonolysis; etherification; enzymatic synthesis; ketalization; saponification; isomerisation; quaternization; formylation; phase transfer reactions; silylations; nitrile synthesis; phosphorylation; ozonolysis; azide chemistry; metathesis; hydrosilylation; coupling reactions; and enzymatic reactions.

### Reference Key

10 honeycomb-based interconnector (monolithic interconnector)

12 honey-comb based interconnector (monolithic interconnector) with integrated clamp

14 multiple-path honeycomb-based interconnector (monolithic interconnector)

20 honeycomb extrusion substrate (portion sawed out from larger)

22 channels

24 machined region

25 ledges (formed by 24 on 20)

26 plugging material

27 O-ring groove features

28 (first) fluid port

30 (second) fluid port

32 (reactant or process fluid) fluid channel (of 22) through 20 after plugging (connecting 28 to at least 30 another)

34 O-ring

36 O-ring plate

38 compressible layer (thin polymer sheet with pressure sensitive adhesive backing)

40 (glass) fluidic module

42 interface clamp(s)

44 clamp screw

46 screw pad

48 clamp pad

50 (generic) O-ring interface for standard or other (typically external access) fluid couplings

52 (additional) O-ring

54 (heat-exchange) O-ring interface(s)

56 (heat exchange) O-ring(s)

58 (heat exchange) fluid port(s)

60 heat exchange fluid path

60A heat exchange path (heat exchange channels) within 20

62 lowered wall(s)

64 reactant (process) fluid path

66 threaded bushing

68 force spreader

70 recess (in 20 for receiving 40)

72 controlled radius corner (in 70)

1. An interconnector for fluidically connecting reactor modules in a millimeter scale continuous flow reactor, the interconnector comprising:
a honeycomb-body substrate having first and second ends and a plurality of channels extending along a common direction from the first end to the second end;
a structure formed on or in the substrate for attaching an interface clamp to the substrate;
wherein one or more of the channels extending through the substrate are open and wherein a plurality of the channels extending through the substrate are closed channels closed off by a plugging material at the ends of the substrate and are surrounding the one or more open channels.

2. An interconnector according to claim 1 wherein the structure formed on or in the substrate for attaching an interface clamp to the substrate further comprises one or more machined side regions on the substrate, said one or more regions extending less then the total length of the substrate in the common direction.

3. An interconnector according to claim 2 wherein the one or more machined side regions on the substrate are centered along the length of the substrate in the common direction.

4. An interconnector according to claim 1 wherein the one or more open channels are arranged in one or more groups of contiguous channels, with each group comprising at least two channels.

5. An interconnector according to claim 4 the one or more groups of contiguous channels each comprises four channels.

6. An interconnector according to claim 1 further comprising one or more integrated heat exchange fluid pathways, which one or more pathways lie at least in part inside the closed channels of the substrate that surround the one or more open channels or groups of channels.

7. An interconnector according to claim 1 further comprising an integrated clamping structure comprising a recess for receiving a fluidic module and a screw thread integrated into the extruded substrate at the recess.

8. A method of making a fluidic connector for fluidically connecting reactor modules in a millimeter scale continuous flow reactor, the method comprising:
machining or cutting out a smaller extruded body substrate from a larger green extruded body, the substrate having channels extending along a common direction, the substrate having first and second ends from which and to which the channels extend;
machining or otherwise forming one or more structures in or on the substrate for attaching an interface clamp to the substrate; and
plugging a plurality of the channels with a plugging material at both ends of the substrate, the plurality of channels being plugged positioned around and surrounding one or more contiguous open channels.

9. The method according to claim 8 wherein the step of machining or otherwise forming one or more structures in or on the substrate for attaching an interface clamp to the substrate further comprises machining one or more side regions on the substrate, said one or more side regions extending less then the total length of the substrate in the common direction.

10. The method according to claim 9 wherein the step of machining one or more side regions on the substrate comprises sanding the one or more sidewalls using a sanding belt.
